(19) United States
(12) Patent Application Publication
(10) Pub. No.: US 2013/0238418 A1
(43) Pub. Date: Sep. 12, 2013

(54) METHOD FOR PLAYING MEDIA CONTENT ON A MEDIA PLAYER

(71) Applicants: Yeshayahu Shai MALCA, Otniel (IL); Bar Netanel SHAHAF, Otniel (IL)

(72) Inventors: Yeshayahu Shai MALCA, Otniel (IL); Bar Netanel SHAHAF, Otniel (IL)

(21) Appl. No.: 13/417,346

(22) Filed: Mar. 12, 2012

(51) Int. Cl. G06Q 30/02

(52) U.S. Cl. 705/14.41

(57) ABSTRACT

A method for playing web-based media content from a media content proprietor (40) on a media player (12, 14), free of charge, the method comprising the steps of downloading media content and advertising content from a content provider (19) to the media player (12, 14); attempting to play on the media player (12, 14) the advertising content a predetermined number of times; counting a number of times the media content is played; transmitting the counted number to the content provider (19); calculating by the content provider (19) a royalty payment for the media content proprietor (40) based on the counted number, and carrying out payment; and the content provider (19) receiving an advertising revenue (44) associated with the actual number of times the advertising content is played; wherein downloading of the advertising content is optionally done together with playing the media content.

### FIELD OF THE INVENTION

The present invention relates to the field of media entertainment. More particularly, the invention relates to a method and apparatus for downloading web-based media content and for playing the content free of charge.

### BACKGROUND OF THE INVENTION

Downloading and playing of web-based media content has become increasingly popular with advances in communication technology and rapidly increasing communication channel bandwidth capacity. A major concern of media content providers is unauthorized downloading and playing of the content. This results in revenue losses for the providers and/or copyright owners of the downloaded media content.

In an effort to reduce revenue losses, several business models have been developed by the media content providers for receiving payment for downloaded content. One of the models is based on paying for the media content prior to downloading, for example, such as with iTunes. Other models are based on including advertising with the downloaded media content so that the contents is free for use by the user and the provider receives payment from the advertisers.

U.S. Patent Application Publication 2009/0216621 to Anderson et al. describes “A media based entertainment service provides user requested media to a user. Video, audio, images and other media may be provided to a user for a fee or free of charge. The media may be provided from the service provider to a client device over a network. When providing media without charge, the media service can incorporate one or more ads into the media. The ads may be targeted to the user, media content, and other features using advertisement parameters. The media service provides for revenue generation associated with the viewing of media files. The media service can generate revenue from advertising, pay-per view, e-commerce, and other financial transactions associated with the media service while focusing on providing the service on user preferences.”

WO 2011/047060 A1, “Cloud Based Media Player And Offline Media Access” with international publication date 21 Apr. 2011 describes “According to one general aspect, a method for playing, in an offline mode, a media file may include receiving, by a web browser operating in an online mode and from a content server, a media file and at least one advertisement associated with the media file. The method may further include caching, within a local file system, the media file and the at least one advertisement. The method may also include playing, in an offline mode, the cached media file and the cached at least one advertisement. The method also comprise detecting a user interaction, while in an offline mode, with the at least one advertisement. The method may include caching the user interaction for further processing when in an online mode.”

### SUMMARY OF THE INVENTION

An aspect of some embodiments of the present invention provides for a method for playing web-based media content from a media content proprietor (40) on a media player (12, 14), free of charge, the method comprising the steps of downloading media content and advertising content from a content provider (19) to the media player (12, 14); attempting to play on the media player (12, 14) the advertising content a predetermined number of times; counting a number of times the media content and/or advertising content is played; transmitting the counted number to the content provider (19); calculating by the content provider (19) a royalty payment for the media content proprietor (40) based on the counted number, and carrying out payment; and the content provider (19) receiving an advertising revenue (44) associated with the actual number of times the advertising content is played; wherein downloading of the advertising content is optionally done together with playing the media content.

In some exemplary embodiments, the method includes storing the downloaded media content and advertising content in the media player (12, 14).

In some exemplary embodiments, the method includes playing the media content when the media player (12, 14) is offline.

In some exemplary embodiments, the method includes storing the number count in the media player (12, 14).

In some exemplary embodiments, the method includes resetting the count in the media player (12, 14) following the transmission.

In some exemplary embodiments, the method includes playing the at least one advertising content when the media player (12, 14) is offline.

In some exemplary embodiments, the method includes transmitting to the content provider (19) a count of a number of times the advertising content is played.

In some exemplary embodiments, the method includes erasing the advertising content from the media player (12, 14) following playing the predetermined number of times.

In some exemplary embodiments, the method includes associating the played advertising content with a subject or theme of the media content played.

In some exemplary embodiments, the method includes downloading the media content and the advertising content through the Internet (10).

In some exemplary embodiments, the method includes downloading the advertising content while playing the media content.

In some exemplary embodiments, the method includes the content provider (19) transferring the royalty payment (45) to the media content proprietor (40).

In some exemplary embodiments, the method includes counting a number of times the advertising content has been played.

The foregoing embodiments of the invention are described and illustrated in conjunction with devices and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a perspective view of an exemplary system for downloading web-based media content from a content provider, according to an embodiment of the present invention;

FIG. 2 which illustrates a flow chart of an exemplary method for downloading media content from a content provider to a personal computer and/or a smart phone for playing free of charge, according to some embodiments of the present invention;

FIG. 3 schematically illustrates a perspective view of an exemplary media content selection page on a website of the content provider of FIG. 1, displayed on the personal computer, according to some embodiments of the present invention;

FIG. 4 schematically illustrates an exemplary interrelationship between an advertiser, a content provider, a user, and a media content proprietor, in a method for computing a royalty payment to the media content proprietor, according to some embodiments of the present invention;

FIG. 5 illustrates a flow chart of the method for computing the royalty payment to the media content proprietor, according to some embodiments of the present invention; and

It should be understood that the drawings are not necessarily drawn to scale.

### DETAILED DESCRIPTION OF PREFERRED EMBODIMENTS

An aspect of some embodiments of the present invention relates to a method for downloading and playing web-based media content free of charge. The method includes downloading media content and advertising content from a content provider to a media player connected online to the content provider, and storing the downloaded content for playing when the media player is offline. Optionally, the media content and advertising content is played while the media player is connected online. The method further includes counting a number of times the media content and/or the advertising is played offline, and reporting the count to the content provider when the media player is reconnected online. Optionally, other information associated with playing of the media content is reported such as, for example, frequency of playing, duration of playing, playing start and/or stop time, and statistical information of interest to the content provider. For convenience hereinafter, reporting information associated with media content may be referred to as “media content report” or “media content reporting”. Optionally, information associated with playing of the advertising content is reported, and which may include number of times played, frequency of playing, duration of playing, playing start and/or stop time, and statistical information of interest to the content provider. For convenience hereinafter, reporting information associated with advertising content may be referred to as “advertising content report” or “advertising content reporting”. Media content and advertising content may include, for example, video, audio, combined video/audio, animation, images, graphics, and the like, including combinations thereof.

In some exemplary embodiments, media and/or advertising content reporting may occur when a user reconnects the media player with the content provider, for example, when downloading new media content. Optionally, media and/or advertising content reporting may occur when reconnected online and after a predetermined interval set by the content provider, for example, after the media content and/or the advertising content has been played a predetermined number of times; or following a certain period of time, for example, once a day, every two days, every four hours, and the like. In some embodiments, the media content number count is reset following transmission of the report.

In some exemplary embodiments, the media player reconnects automatically for media and/or advertising content reporting. Optionally, the automatic reconnection is at predetermined time periods, for example, once a day, twice a day, every two days, every three days, or more. Optionally, the content provider sets the automatic reconnection time and/or frequency in the media player. Optionally, the user may set the automatic reconnection time and/or frequency in the media player by selecting from a menu of content provider automatic reconnection settings.

In some exemplary embodiments, the media content count in the media player is reset following transmission of the played media and/or advertising content report to the content provider. Optionally, the advertising content count is reset following transmission of the played media and/or advertising content report to the content provider. Optionally, the resetting of the counts are initiated by the content provider. Additionally or alternatively, resetting of the counts are self-initiated by the media player.

In some exemplary embodiments, the advertising content stored in the media player is erased after being played a predetermined number of times. Optionally, the content provider initiates erasure of the stored advertising content. Additionally or alternatively, erasure of stored advertising content is automatically done by the media player following playing a predetermined number of times.

In some exemplary embodiments, the advertising content is pushed by the content provider and stored in the media player while the player is connected online for downloading media content. Optionally, the advertising content is pushed and stored in the media player by the content provider forcing a connection with the media player. Additionally or alternatively, the advertising content is pushed and stored in the media player when the media player reconnects online for reporting count of media content playing.

In some exemplary embodiments, the advertising content and/or the media content includes instructions for controlling playing of the advertising content. For example, the instructions may include information as to when the advertising content is to be played, how many times to be played, a duration length of playing, and the like. In some embodiments, the instruction include playing advertising content associated with the media content selected to be played, for example, by subject, by theme, and the like. In some embodiments, the instructions include the erasure instructions for the advertising content. Optionally, the instructions are downloaded separately from the advertising content and/or the media content.

In some exemplary embodiments, the instructions are pushed by the content provider and stored in the media player while the player is connected online for downloading media and/or advertising content. Optionally, the instructions are pushed and stored in the media player by the content provider forcing a connection with the media player. Additionally or alternatively, the instructions are pushed and stored in the media player when the media player reconnects online for reporting count of media content playing.

In some exemplary embodiments, the advertising content is played prior to initiating playing of media content. Optionally, the advertising content is played during playing of media content, for example, during one or more interruptions in the playing of the media content. Additionally or alternatively, the advertising content is played simultaneously with playing of the media content, for example, as video advertising content displayed while audio media content is being played. Additionally or alternatively, the advertising content is played following termination of playing of media content. Additionally or alternatively, the advertising content is played at times not associated with playing of media content, or even randomly.

In some exemplary embodiments, the media player may be a dedicated device configured for playing the downloaded media content and advertising content. The media player includes a processor for controlling device operations, including decoding of different types of encoding/compression formats known in the art and used by the content provider for sending the downloaded content; counting playing of the media content offline; controlling playing of the advertising media; communications interfacing with the content provider; and more. The media player further includes a non-volatile memory known in the art. Optionally, a volatile memory is included. Optionally, the media player may accommodate an external memory such as, for example, a flash card or an external hard disk, or other types of USB detachable non-volatile memory devices. In some embodiments, the media player may include a smart phone, a personal digital assistant (PDA), a mobile telephone, a personal computer, a laptop computer, a tablet computer, or other processor based device suitable for communicating with the content provider for downloading content and reporting counting of playing of media content and/or advertising content. Additionally or alternatively, the media player is connectable to the processor based device which communicates with the content provider and data transfer between the content provider and the media player is through the device.

In some exemplary embodiments, the media and advertising content is downloaded from the content provider through the Internet. Optionally, communications between the media player and the content provider is through a wireless terrestrial link. Optionally, the link includes a wireless area network such as, for example, WiFi, WPAN (wireless personal area network), WiMAX (Broadband Wireless Access), MBWA (Mobile Broadband Wireless Access), and/or WRAN (Wireless Regional Area Network), or any combination thereof. Optionally, the link includes a cellular phone network. In some embodiments, the communications between the media player and the content provider combines a terrestrial link and a satellite link. Additionally or alternatively, communications between the media player and the content provider may include a wired link such as, for example, through telephone lines, Ethernet lines, power lines, CATV lines, optical fibers, among others.

In some exemplary embodiments, the media player receives the media content from a hard storage medium such as, for example, a CD (compact disk) or an attachable non-volatile memory. Optionally, the advertising content and reporting of playing of media content is by communicating online with the content provider.

In some exemplary embodiments, the content provider includes a media server adapted to download the media and the advertising content to the media player. Additionally, the content provider includes a data server adapted to receive the reporting of counting of playing of media content from the media player. Optionally, other data is transferred from the media player to the data server, for example, identification of the media player, number of time advertising content has been played, and/or other identification and statistical data, as deemed appropriate by the content provider. Optionally, the media server and the data server are included in a same server.

An aspect of some embodiments of the present invention relates to a method of computing a royalty payment to a proprietor of web-based media content played free of charge on a media player. The method includes a content provider selling advertising time to an advertiser and downloading advertising content associated the advertiser to the media player. The advertising content is played one or more times on the media player according to the advertising time purchased by the advertiser. The media player counts a number of times the media content is played and reports the count to the content provider for computing the royalty. Optionally, counting includes the number of times the media content is played while offline. Optionally, the number of times the media content is played online is counted. In some embodiments, royalty payment to the proprietor of the web-based media content is from the advertising revenues.

In some exemplary embodiments, the media content includes a digital signature generated by the content provider for associating playing of the media content with a particular media player, thereby preventing the media content to be played by an unauthorized media player. Optionally, the media content is protected for preventing incorrect reporting of the number of times played to the data server. Additionally, the media content is protected for preventing incorrect reporting of the identification of the media content to the data server.

The present invention will be understood from the following detailed description of preferred embodiments, which are meant to be descriptive and not limiting. For the sake of brevity, some well-known features, methods, systems, procedures, components, circuits, and so on, are not described in detail.

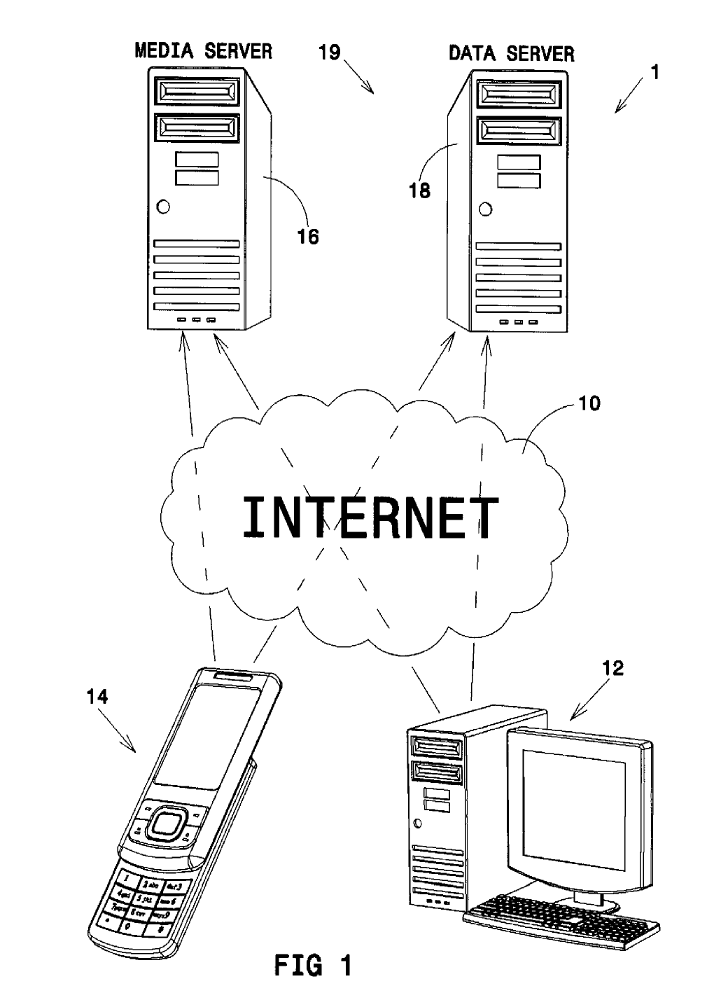

Reference is now made to FIG. 1 which schematically illustrates a perspective view of an exemplary system 1 for downloading web-based media content from a content provider 19, according to an embodiment of the present invention. System 1 includes a media player, for example a personal computer 12 and/or a smart phone 14, onto which media content and advertising content may be downloaded for playing free of charge. Downloading of the media and advertising content is through a wireless and/or wired communication system 10, which may include use of the Internet.

In some exemplary embodiments, content provider 19 includes a media server 16 and a data server 18. Media server 16 downloads the media content and advertising content to personal computer 12 and to smart phone 14. Data server 18 receives identification and statistical data from personal computer 12 and from smart phone 14. Optionally, the statistical data includes the number of times particular media content has been played while the media players are offline. In some embodiments, personal computer 12 and smart phone 14 communicate with media server 16, for example, for indicating to the media server which media content to download. Optionally, this information is communicated by personal computer 12 and smart phone 14 to data server 18 which then instructs media server 16 regarding the content to download. In some embodiments, media server 12 and data server 14 are respectively connected to databases wherein are stored the information delivered/received by each server. Optionally, the databases are included in a single database.

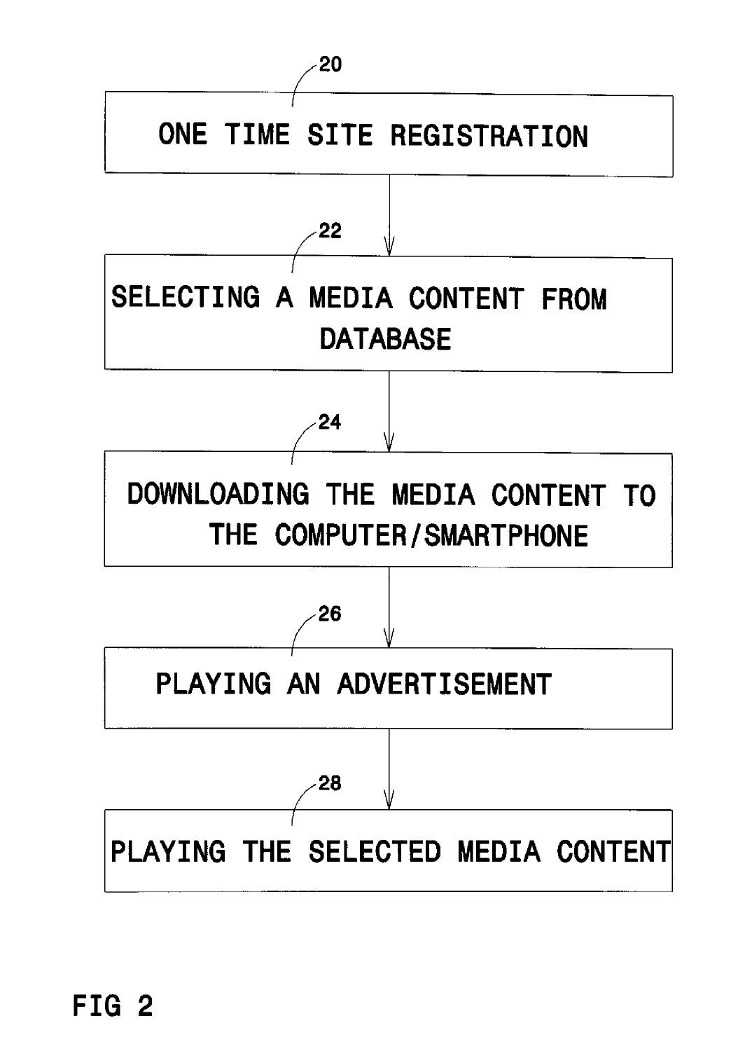

Reference is now made to FIG. 2 which illustrates a flow chart of an exemplary method for downloading media content from content provider 19 to personal computer 12 and/or smart phone 14 for playing free of charge, according to some embodiments of the present invention.

At 20 a user registers to download media content from a website of content provider 19. Optionally, user registration is one time and requires that the user connect online to content provider 19. Optionally, the user logs into the website every time there is an online connection for downloading media content. Additionally or alternatively, personal computer 12 and/or smart phone 14 are automatically identified by content provider 19 after first time registration. In some embodiments, registration and/or login is by connecting to data server 18. Optionally, registration and/or login are through media server 16. In some embodiments, a same user may be connected to content provider 19 with both personal computer 12 and smart phone 14.

At 22, once connected online to content provider 19, the user selects the media content to be downloaded from the database of media server 16 to personal computer 12 and/or smart phone 14.

At 24, the media content is downloaded from content provider 19 to personal computer 12 and/or smart phone 14. Optionally, the media content is downloaded for playing while connected online. Additionally or alternatively, the media content is for storing in a memory of personal computer 12 and/or smartphone 14 for playing at a later time when offline.

At 26, personal computer 12 and/or smart phone 14 play advertising content. Optionally, the advertising content is played when connecting online. Additionally or alternatively, the advertising content is played following disconnecting from content provider 19. Additionally or alternatively, the advertising content is played when offline and following user selection to play media content stored in memory in personal computer 12 and/or smart phone 14. Additionally or alternatively, advertising content is played according to the downloaded instructions, and which may include, for example, a frequency of playing, a duration of playing, and when to play (e.g. before playing the media content, following playing of the media content, during playing of the media content). In some embodiments, the advertising content played is according to a subject or theme of the selected media content. Optionally, the advertising content is associated with a user profile. In some embodiments, a number of times the advertising content is played are recorded in a counter in personal computer 12 and/or smart phone 14 for reporting to content provider 19.

At 28, the selected media content is played in personal computer 12 and/or smart phone 14. Playing of the media content is recorded in a counter in personal computer 12 and/or smart phone 14 for reporting to content provider 19. Optionally, the counter for the advertising content and for the media content is a same counter. Optionally, a length of time of duration of playing is recorded. Optionally, initiating playing of the media content is recorded. Additionally or alternatively, end of playing of the media content is recorded.

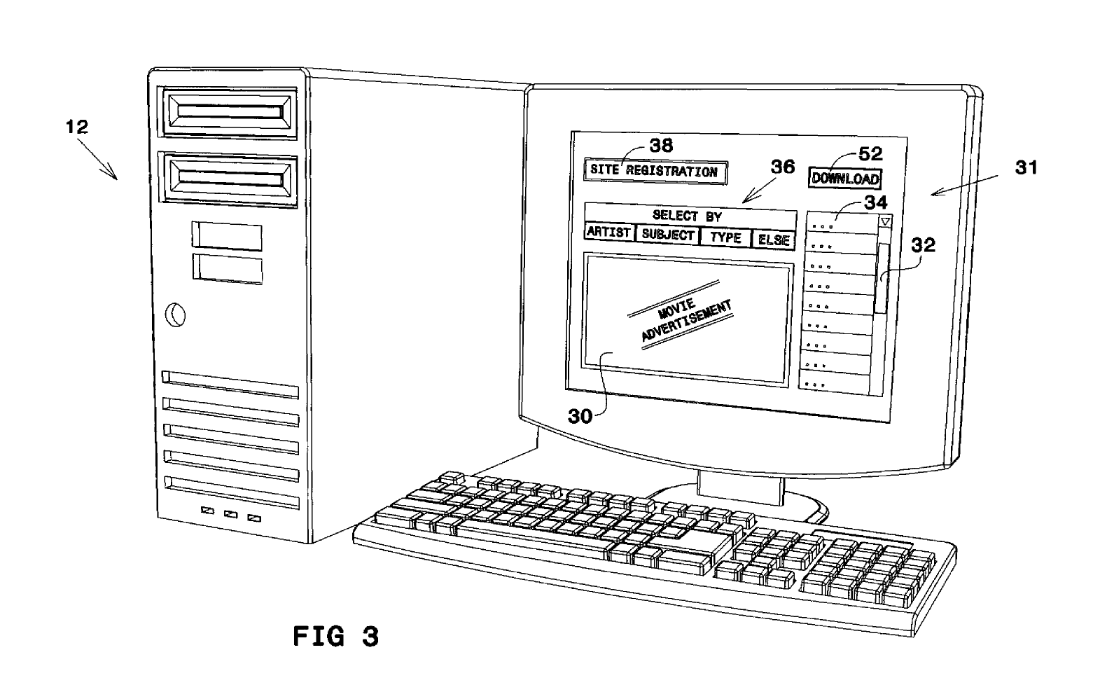

Reference is now made to FIG. 3 which schematically illustrates a perspective view of an exemplary media content selection page 31 on the website of content provider 19, displayed on personal computer 12, according to some embodiments of the present invention. In some embodiments, media content selection page 31 includes a first time site registration button 38 for allowing the user to register with content provider 19 for downloading free media content. Optionally included is a content selection menu 36 for allowing the user to select the media content to be downloaded by any number of possible selections, or combination of selections, for example, by artist (creator), subject of media content, type of media content, and the like. Optionally, a media content list 34 displays the possible detailed selections associated with the selection of the user in content selection menu 36, a scroll button 32 included therein to allow the user to scroll up and down the list. Downloading of the media content may be done through a download button 52 on media content selection page 31 which allows the user to initiate downloading of the media content. Optionally, media content selection page 31 includes a media content viewer 30 wherein the media content may be played for viewing and/or listening.

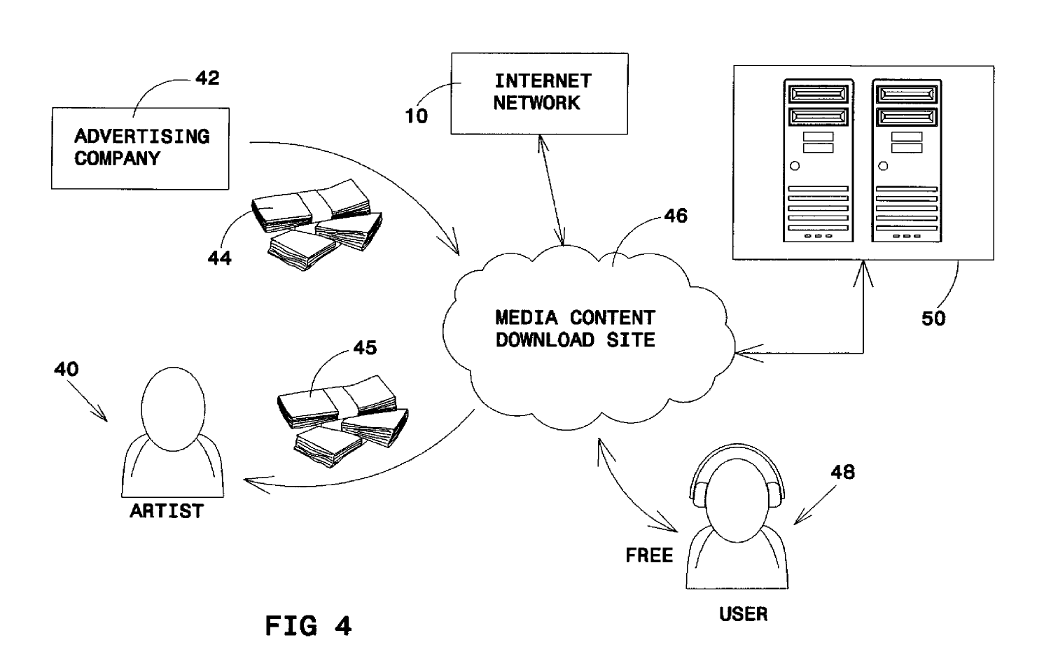

Reference is now made to FIG. 4 which schematically illustrates an exemplary interrelationship between an advertiser 42, a content provider 50, a user 48, and a media content proprietor 40, in a method for computing a royalty payment to the proprietor of web-based media content played free of charge, according to some embodiments of the present invention.

Content provider 50 receives revenues 44 from advertising company 42 for playing advertising content on a media player of user 48. Optionally, from the received revenues 44, content provider pays a royalty 45 to media content proprietor 40 for each time a media content belonging to the media content proprietor is played by user 48. Optionally, the media content is played while being downloaded by user 48 from a media content downloading site operated by content provider 50. Additionally or alternatively, the media content is played following downloading by user 48 and while offline. Optionally, downloading is through the Internet through communications network 10.

Royalty payment 45 is computed by content provider 50 by receiving from user 48 a report of the number of times the media content of media content proprietor 40 is played. Optionally, the report includes the number of times the media content has been played offline. Optionally, the report includes the number of times the media content has been played online while connected to media content downloading site 46.

Revenues 44 are paid by advertising company 42 to content provider 50 for advertising content downloaded to the media player of user 48 and for playing of the advertising content on the media player. In some embodiments, revenues 44 may be associated with a frequency of playing of the advertising content on the media player, with a number of times of playing, with a duration of playing, with a type of advertising content (e.g. video, audio, combined video/audio, etc.), or other advertising revenue-producing parameters, or any combination thereof. For example, advertising company 42 may pay revenues 44 for playing an advertising content frequently over a short period of time, for example, before, during and after finishing playing any media content, during a period of five days, as part of an advertising campaign. In another example, advertising company 42 may pay revenues 44 for playing the advertising content once a day when the media player is first turned on by user 48, or once a day at a random time.

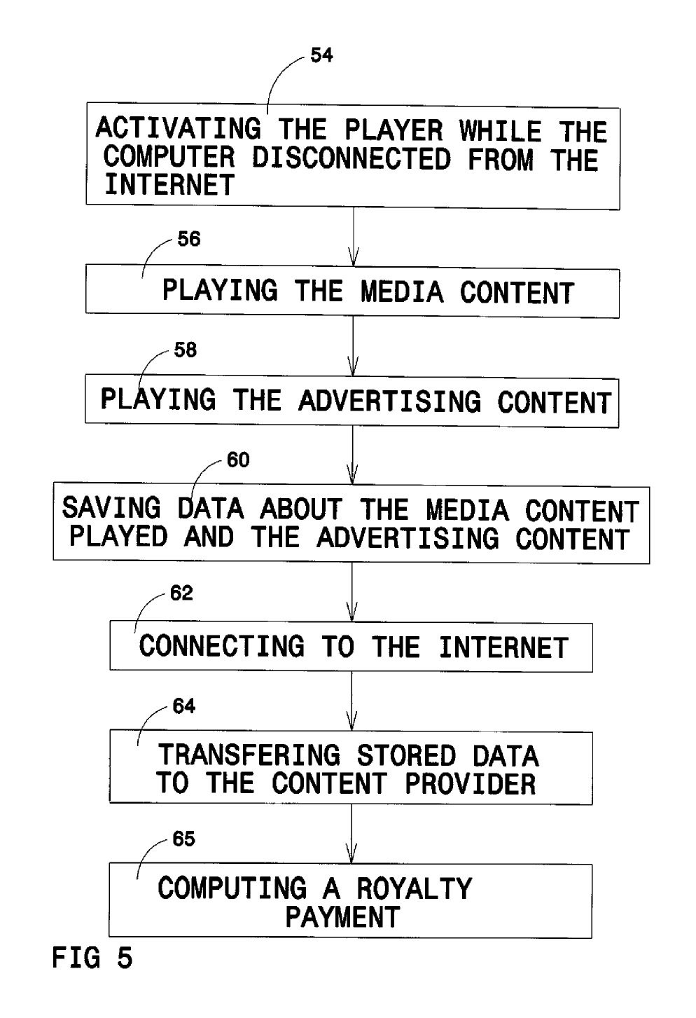

Reference is now also made to FIG. 5 which illustrates a flow chart of the method for computing the royalty payment to media content proprietor 40, according to some embodiments of the present invention.

At 54, the media player is disconnected from media content downloading site 46 and Internet network 10 by user 48 following downloading of media content. Optionally, advertising content was downloaded.

At 56, user 48 plays the media content recently downloaded. Alternatively, user 48 plays the media content previously stored in the media player.

At 58, advertising content is played during playing of media content. Additionally or alternatively, the advertising content is played after the media content has been played. In some embodiments, the advertising content is downloaded together with the downloaded media content. Additionally or alternatively, the advertising content was previously downloaded and stored in the memory of the media player.

At 60, the media player stores the information associated with the played media content, including the counter data regarding the number of times particular media content was played since last going offline. Optionally, other information is registered by the counter, which may include for example start and/or stop time of playing of the media content, playing time, and statistical information of interest to content provider 50 for computing royalty payment 45. In some embodiments, the media player stores advertising content information associated with playing of the advertising content, and which may include information, including number of times played, duration, start and/or stop time, and statistical information of interest to content provider 50 and associated with revenues 44 from advertising company 42.

At 62, the media player connects to media content downloading site 46 through Internet network 10. Optionally, the connection is made by user 48 going into the site for downloading new media content.

At 64, the stored media content playing data and/or advertising content playing data is transferred from the media player to content provider 50 through Internet network 10. Optionally, user 48 initiates the data transfer for downloading new media content. Additionally or alternatively, the data is transferred automatically by the media player as part of a synchronization process.

At 65, content provider 50 receives the media content playing information, including the number of times the media content was played, and computes royalty payment 45 to media content proprietor 40. Additionally or alternatively, content provider 50 receives advertising content playing information and updates the information stored in the server database associated with revenues 44. Optionally, content provider 50 sends instructions to the media player modifying previous instructions associated with playing of the advertising content.

In the figures and/or description herein, the following reference numerals have been mentioned:

### PART DESCRIPTION REFERENCE NO.

Media Content Download System 1

Communication Network 10

Personal Computer 12

Smart Phone 14

Media Server 16

Data Server 18

Content Provider 19

Media Content Viewer 30

Media Content Selection Page 31

Content List Scroller 32

Content List 34

Content Selection Menu 36

Site registration button 38

Web-content Proprietor 40

Advertising Company 42

Revenue 44

Royalty 45

Media Content Downloading Site 46

User 48

Server 50

Content Download Button 52

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A method for playing web-based media content from a media content proprietor (40) on a media player (12, 14), free of charge, the method comprising the steps of:
downloading media content and advertising content from a content provider (19) to the media player (12, 14);
attempting to play on the media player (12, 14) the advertising content a predetermined number of times;
counting a number of times the media content is played;
transmitting the counted number to the content provider (19);
calculating by the content provider (19) a royalty payment for the media content proprietor (40) based on the counted number, and carrying out payment; and
the content provider (19) receiving an advertising revenue (44) associated with the actual number of times the advertising content is played;
wherein downloading of the advertising content is optionally done together with playing the media content.

2. A method according to claim 1, further comprising the step of: storing the downloaded media content and advertising content in the media player (12, 14).

3. A method according to claim 1, further comprising the step of: playing the downloaded media content when the media player (12, 14) is offline.

4. A method according to claim 1, further comprising the step of: storing the number count in the media player (12, 14).

5. A method according to claim 1, further comprising the step of: resetting the count in the media player (12, 14) following the transmission.

6. A method according to claim 1, further comprising the step of: playing the advertising content when the media player (12, 14) is offline.

7. A method according to claim 1, further comprising the step of: transmitting to the content provider (19) a count of a number of times the advertising content is played.

8. A method according to claim 1, further comprising the step of: erasing the advertising content from the media player (12, 14) following playing the predetermined number of times.

9. A method according to claim 1, further comprising the step of: associating the advertising content with a subject or theme of the media content played.

10. A method according to claim 1, further comprising the step of: downloading the media content and the advertising content through the Internet (10).

11. A method according to claim 1, further comprising the step of: downloading the advertising content while playing the media content.

12. A method according to claim 1, further comprising the step of: the content provider (19) transferring the royalty payment (45) to the media content proprietor (40).

13. A method according to claim 1, further comprising the step of counting a number of times the advertising content is played.
